(19) United States
(12) Patent Application Publication
(10) Pub. No.: US 2018/0358653 A1
(43) Pub. Date: Dec. 13, 2018

(54) METHOD FOR PRODUCING A SULFIDE SOLID ELECTROLYTE HAVING AN ARGYRODITE TYPE CRYSTAL STRUCTURE

(71) Applicant: IDEMITSU KOSAN CO., LTD., Chiyoda-ku (JP)

(72) Inventors: Junpei MARUYAMA, Sodegaura-shi (JP); Masao AIDA, Ichihara-shi (JP); Shota TOTSUKA, Sodegaura-shi (JP); Naoya MASUDA, Sodegaura-shi (JP)

(73) Assignee: IDEMITSU KOSAN CO., LTD., Chiyoda-ku (JP)

(21) Appl. No.: 16/000,265

(22) Filed: Jun. 5, 2018

(30) Foreign Application Priority Data
Jun. 5, 2017 (JP) 2017-111036

(51) Int. Cl. H01M 10/0562; H01M 10/0525

(52) U.S. Cl. CPC H01M 10/0562; H01M 2300/0068; H01M 10/0525

(57) ABSTRACT

A method for producing a solid electrolyte comprises heat-treating a raw material comprising lithium, sulfur, and phosphorus as constituent elements in a flowing state, thereby manufacturing a sulfide solid electrolyte comprising an argyrodite type crystal structure.

### TECHNICAL FIELD

Embodiments described herein relate generally to a method for producing a sulfide solid electrolyte having an argyrodite type crystal structure.

### BACKGROUND ART

Along with the rapid spread of information-related devices and communication devices such as personal computers, video cameras, and mobile telephones in recent years, development of batteries used as their power sources is considered important. Among batteries, a lithium-ion battery is attracting attention from the perspective of being high in energy density.

A liquid electrolyte comprising a flammable organic solvent is used in conventional lithium-ion batteries currently on the market. Therefore, conventional lithium-ion batteries need attachment of a safety device which suppresses a temperature rise during a short circuit, and improvements in structure and material to prevent a short circuit. In contrast, a solid-state lithium-ion battery which is totally solidified by changing a liquid electrolyte to a solid electrolyte does not use a flammable organic solvent therein, and therefore allows simplification of a safety device, and is considered advantageous in terms of manufacturing cost and productivity.

A sulfide solid electrolyte is known as a solid electrolyte used in a lithium-ion battery. While there are various known crystal structures of sulfide solid electrolytes, a stable crystal structure which is difficult to change in structure in a wide temperature range is suitable from the perspective of widening the use temperature area of a battery. As such a sulfide solid electrolyte, for example, a sulfide solid electrolyte having an argyrodite type crystal structure (which may hereinafter be referred to as an argyrodite type solid electrolyte) has been developed.

As a method of manufacturing an argyrodite type solid electrolyte, for example, Patent Document 1 describes a method of heating a raw material at 550° C. for 6 days, and then gradually cooling the material. Moreover, Patent Documents 2 to 5 describe a method of grinding and mixing a raw material with a ball mill for 15 hours, and then heat-treating the material at 400 to 650° C. In addition, Non-Patent Document 1 describes a method of mechanically milling a material with a planetary ball mill for 20 hours, and then heat-treating the material at 550° C.

### RELATED ART DOCUMENTS

### Patent Documents

[Patent Document 1] JP-A-2010-540396

[Patent Document 2] WO2015/011937

[Patent Document 3] WO2015/012042

[Patent Document 4] JP-A-2016-24874

[Patent Document 5] WO2016/104702

### Non-Patent Document

[Non-Patent Document 1] 82-th proceedings of the Institute of Electrical Engineers of Japan (2015), 2H08

### SUMMARY OF INVENTION

Although some argyrodite type solid electrolytes have high ion conductivity, further improvements are requested.

Moreover, because a long-time heat treatment or a long-time grinding and mixing process has been needed to manufacture an argyrodite type solid electrolyte having high ion conductivity, a manufacturing method that can shorten a manufacturing time is requested.

One object of the present invention is to provide a method for producing an argyrodite type solid electrolyte having high ion conductivity.

Another object of the present invention is to provide a method for producing an argyrodite type solid electrolyte in a shorter time than heretofore.

As a result of intensive studies to solve the problem described above, the present inventors found that a solid electrolyte having high ion conductivity could be obtained when a raw material was heat-treated in a flowing state, thereby completing the present invention.

According to one embodiment of the present invention, it is possible to provide a method for producing a solid electrolyte, comprising heat-treating a raw material comprising lithium, sulfur, and phosphorus as constituent elements in a flowing state, thereby manufacturing a sulfide solid electrolyte comprising an argyrodite type crystal structure.

According to one embodiment of the present invention, it is possible to manufacture an argyrodite type solid electrolyte having high ion conductivity. Moreover, according to one embodiment of the present invention, it is possible to manufacture an argyrodite type solid electrolyte in a shorter time than heretofore.

### BRIEF DESCRIPTION OF DRAWINGS

FIG. 1 is a plan view, which is broken in the centers of rotation shafts, of one example of a multiaxial kneader used in a manufacturing method according to one embodiment of the present invention;

FIG. 2 is a plan view, which is broken perpendicularly to the rotation shafts, of a part where there are provided paddles of the rotation shafts of one example of the multiaxial kneader used in the manufacturing method according to one embodiment of the present invention;

FIG. 3 is an X-ray diffraction pattern of a solid electrolyte of Example 1;

FIG. 4 is an X-ray diffraction pattern of a solid electrolyte of Example 2;

FIG. 5 is an X-ray diffraction pattern of a solid electrolyte of Example 3;

FIG. 6 is an X-ray diffraction pattern of a solid electrolyte precursor of Example 4;

FIG. 7 is an X-ray diffraction pattern of a solid electrolyte of Example 4; and

FIG. 8 is an X-ray diffraction pattern of a solid electrolyte of Example 5.

### MODE FOR CARRYING OUT INVENTION

A method for producing an argyrodite type solid electrolyte according to one embodiment of the present invention comprises heat-treating a raw material comprising lithium, sulfur, and phosphorus as constituent elements in a flowing state. By heat-treating the raw material in a flowing state, the ion conductivity of a solid electrolyte to be obtained is increased. Moreover, for example, if the heat treatment is conducted by use of a rotary furnace, a treatment amount can be greater than heretofore, and a manufacturing time can be therefore shortened.

A mixture obtained by combining two or more kinds of compounds or simple substances (hereinafter, referred to as a raw material mixture), or a solid electrolyte precursor obtained from this mixture is used as a raw material so that constituent elements of the argyrodite type solid electrolyte are contained as a whole.

As a compound constituting the raw material mixture, it is possible to use a compound having, as constituent elements thereof, lithium, sulfur, phosphorus, and any one or more elements such as halogen.

Compounds comprising lithium include, for example, lithium sulfide (Li₂S), lithium oxide (Li₂O), and lithium carbonate (Li₂CO₃). Lithium sulfide is preferable.

Compounds comprising phosphorus include, for example, phosphorus sulfide such as diphosphorus trisulphide (P₂S₃) and diphosphorus pentasulfide (P₂S₅), and a phosphorus compound such as sodium phosphate (Na₃PO₄). Among others, phosphorus sulfide is preferable, and diphosphorus pentasulfide (P₂S₅) is more preferable.

A compound comprising halogen includes, for example, a compound represented by a general formula (Mₗ-Xₘ).

In the formula, M indicates sodium (Na), lithium (Li), boron (B), aluminum (Al), silicon (Si), phosphorus (P), sulfur (S), germanium (Ge), arsenic (As), selenium (Se), tin (Sn), antimony (Sb), tellurium (Te), lead (Pb), bismuth (Bi), or each of the above elements to which an oxygen element or a sulfur element is bonded. Li or P is preferable, and lithium (Li) is particularly preferable.

X is a halogen element selected from the group consisting of F, Cl, Br, and I.

Moreover, l is an integer of 1 or 2, and m is an integer of 1 to 10. When m is an integer of 2 to 10, that is, when there are a plurality of Xs, Xs may be the same or different. For example, in SiBrCl₃ which will be described later, m is 4, and X comprises different elements Br and Cl.

Halogen compounds represented by the above formula specifically include, sodium halide such as Nal, NaF, NaCl, and NaBr; lithium halide such as LiF, LiCl, LiBr, and LiI; boron halide such as BCl₃, BBr₃, and Bl₃; aluminum halide such as AlF₃, AlBr₃, AlI₃, and AlCl₃; silicon halide such as SiF₄, SiCl₄, SiCl₃, Si₂Cl₆, SiBr₄, SiBrCl₃, SiBr₂Cl₂, and SiI₄; phosphorus halide such as PF₃, PF₅, PCl₅, PCl₅, PSCl₃, POCl₃, PBr₃, PSBr₃, PBr₅, POBr₃, Pl₃, PSI₅, P₂Cl₄, and P₂I₄; sulfur halide such as SF₂, SF₄, SF₆, S₂F₁₀, SCl₂, S₂Cl₂, and S₂Br₂; germanium halide such as GeF₄, GeCl₄, GeBr₄, Gel₄, GeF₂, GeCl₂, GeBr₂, and Gel₁; arsenic halide such as AsF₃, AsCl₃, AsBr₃, AsI₃, and AsF₅; selenium halide such as SeF₄, SeF₆, SeCl₂, SeCl₄, Se₂Br₂, and SeBr₄; tin halide such as SnF₄, SnCl₄, SnBr₄, SnI₄, SnF₂, SnCl₂, SnBr₂, and SnI₂; antimony halide such as SbF₃, SbCl₃, SbBr₃, SbI₃, SbF₅, and SbCl₆; tellurium halide such as TeF₄, Te₂F₁₀, TeF₆, TeCl₂, TeCl₄, TeBr₂, TeBr₄, and TeI₄; lead halide such as PbF₄, PbCl₄, PbF₂, PbCl₂, PbBr₂, and Pbl₂; and bismuth halide such as BiF₃, BiCl₃, BiBr₃, and Bilₐ.

Among others, lithium halide or phosphorus halide is preferable, and LiCl, LiBr, LiI or PBr₃ is more preferable, LiCl, LiBr or LiI is further preferable, and LiCl or LiBr is particularly preferable.

One of the kinds of halogen compounds described above may be singly used, or a combination of two or more kinds may be used.

A simple substance constituting the raw material mixture includes a lithium metallic simple substance, a phosphorus simple substance such as red phosphorus, or a sulfur simple substance.

The above-described compounds and simple substances that are industrially manufactured and sold can be used without any particular limitation. The compounds and simple substances are preferably high in purity.

Two or more kinds of compounds or simple substances described above are used in combination so that the raw material mixture comprises lithium, phosphorus, sulfur, and any element such as halogen as a whole.

In one embodiment of the present invention, the raw material mixture comprises a lithium compound, a phosphorus compound, and a halogen compound. At least one of the lithium compound and the phosphorus compound preferably comprises a sulfur element. A combination of Li₂S, phosphorus sulfide, and lithium halide is more preferable, and a combination of Li₂S, P₂S₅, and LiCl and/or LiBr is further preferable.

For example, when Li₂S, P₂S₅, LiCl, and LiBr are used as the raw materials of the argyrodite type solid electrolyte, the molar ratio of the input raw materials can be set at Li₂S:P₂S₅: the sum of LiCl and LiBr=30 to 60:10 to 25:15 to 50. Preferably, the molar ratio of Li₂S:P₂S₅: the sum of LiCl and LiBr is 45 to 55:10 to 15:30 to 50. More preferably, the molar ratio of Li₂S:P₂S₅: the sum of LiCl and LiBr is 45 to 50:11 to 14:35 to 45. Further preferably, the molar ratio of Li₂S:P₂S₅: the sum of LiCl and LiBr is 46 to 49:11 to 13:38 to 42.

In the present invention, the raw material mixture may be directly input to a device, and heat-treated in a flowing state, or a solid electrolyte precursor may be previously formed from the raw material mixture, and the solid electrolyte precursor may be input to the device. In one embodiment of the present invention, the solid electrolyte precursor is preferably used as raw material in that the yield of a solid electrolyte improves and in that the adhesion of the raw material mixture to the inner wall of the device can be suppressed.

The solid electrolyte precursor can be formed, for example, by applying mechanical stress to the raw material mixture. Herein, “applying mechanical stress” is to mechanically apply shear stress, impact force, or the like. Means of applying mechanical stress include, for example, a grinder such as a planetary ball mill, a vibrating mill, a tumbling mill, and a beads mill, and a kneader such as a uniaxial kneader and a multiaxial kneader. Among others, the vibrating mill or the multiaxial kneader is preferable.

Alternatively, the solid electrolyte precursor can be formed, for example, by heat-treating the raw material mixture. A heat treatment temperature is preferably 230 to 550° C. Mechanical stress may be applied to a heat-treated product.

The solid electrolyte precursor preferably comprises glass, glass ceramics, or crystal. In the present application, glass means the case where as a result of an X-ray diffraction measurement, a diffraction peak derived from crystal is not observed, or the case where a diffraction peak derived from crystal is observed, but the peak intensity is low (an object material mainly comprises an amorphous material). On the other hand, glass ceramics mean the case where as a result of an X-ray diffraction measurement, a diffraction peak derived from crystal is observed, and crystal means a material in which no halo pattern derived from glass is observed and which only comprises crystal. Glass ceramics may comprise an amorphous part. That is, glass ceramics also comprise a mixture of glass and crystal.

By applying mechanical stress to the raw material mixture or heat-treating the raw material mixture, some of the compounds or simple substances react, and a PS₄³⁻ structure constituting an argyrodite type crystal structure is formed. If the PS₄³⁻ structure is formed, diffraction peaks derived from the compounds or the simple substances decrease, and a halo pattern derived from glass or a diffraction peak derived from crystal comprising the PS₄³⁻ structure is observed, in powder X-ray diffraction. The crystal comprising the PS₄³⁻ structure includes a β-Li₃Ps₄ type crystal structure and a γ-Li₃PS₄ type crystal structure in addition to the argyrodite type crystal structure. For example, the β-Li₃PS₄ type crystal structure can be obtained by heat-treating the raw material mixture at 230° C. to 350° C., and the γ-Li₃PS₄ type crystal structure can be obtained by heat-treating the raw material mixture at 400° C. to 550° C.

Among the diffraction peaks derived from the compounds or the simple substances in the solid electrolyte precursor, no diffraction peak derived from phosphorus sulfide is preferably observed.

The vibrating mill or the multiaxial kneader used to form the solid electrolyte precursor is not particularly limited. The multiaxial kneader preferably comprises two or more axes. The multiaxial kneader is not particularly limited in other configurations as long as the multiaxial kneader comprises a casing, and two or more rotation shafts which are laid to extend through the casing in the longitudinal direction thereof and which are provided with paddles (screws) along the axial direction, the multiaxial kneader comprises a supply opening for a raw material at one end in the longitudinal direction of the casing, and a discharge opening at the other end, and the multiaxial kneader produces mechanical stress by the interaction of two or more rotational movements. If the two or more rotation shafts provided with the paddles of such a multiaxial kneader are rotated, mechanical stress can be produced by the interaction of two or more rotational movements, and the mechanical stress can be applied to the raw material moving from the supply opening toward the discharge opening along the rotation shafts so that a reaction is caused to the raw material.

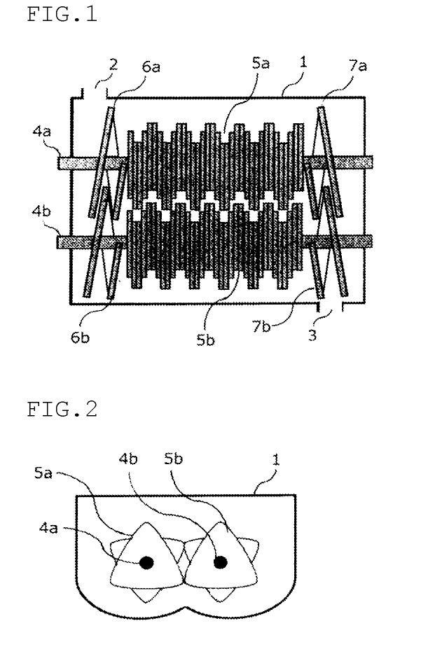

One preferred example of a multiaxial kneader that can be used in one embodiment of the present invention is described with reference to FIGS. 1 and 2. FIG. 1 is a plan view broken in the centers of rotation shafts of the multiaxial kneader. FIG. 2 is a plan view, which is broken perpendicularly to the rotation shafts, of a part where there are provided paddles of the rotation shafts.

The multiaxial kneader shown in FIG. 1 is a biaxial kneader comprising a casing 1 provided with a supply opening 2 at one end, and a discharge opening 3 at the other end, and two rotation shafts 4a and 4b extending through the longitudinal direction of the casing 1. The rotation shafts 4a and 4b are provided with paddles 5a and 5b, respectively. A compound or a simple substance enters the casing 1 from the supply opening 2, mechanical stress is applied thereto by the paddles 5a and 5b, the compound or the simple substance reacts, and an obtained solid electrolyte precursor is discharged from the discharge opening 3.

The number of the rotation shafts 4 is not particularly limited as long as there are two or more rotation shafts 4. When versatility is considered, the number of the rotation shafts 4 is preferably 2 to 4, and is more preferably 2. Moreover, the rotation shafts 4 are preferably mutually parallel shafts.

The paddle 5 is provided in the rotation shaft to knead a compound or the like, and is also called a screw. The sectional shape of the paddle is not particularly limited, and includes a circular shape, an elliptic shape, a substantially quadrangular shape, and the like in addition to a substantially triangular shape in which each side of an equilateral triangle is in the shape of a uniformly projecting arc as shown in FIG. 2. The paddle may have a shape based on the above shapes having a cutout in a part.

When a plurality of paddles are provided, each paddle may be provided in the rotation shaft at a different angle, as shown in FIG. 2. When the effect of mixing is to be further obtained, mesh-type paddles may be selected.

The rotation number of the paddle is not particularly limited, but is preferably 40 to 300 rpm, more preferably 40 to 250 rpm, and further preferably 40 to 200 rpm.

The multiaxial kneader may comprise a screw 6 on the supply opening 2 side as shown in FIG. 1 in order to smoothly supply the raw material into the kneader. Moreover, the multiaxial kneader may comprise a reverse screw 7 on the discharge opening 3 side as shown in FIG. 1 so that the mixture obtained through the paddles 5 does not retain in the casing.

A kneader on the market can also be used as the multiaxial kneader. Multiaxial kneaders on the market include, for example, a KRC kneader (manufactured by Kurimoto, Ltd.), and the like.

Integrated power required for processing by the kneader varies depending on the kinds of elements constituting a solid electrolyte to be obtained, a composition ratio, and temperature, and therefore may be suitably adjusted. For example, it is only necessary to make an adjustment so that integrated power per path is 0.05 kWh/kg or more and 10 kWh/kg or less, by adjusting the number of rotation or the like of the paddle. Integrated power for one pass is more preferably 0.1 kWh/kg or more and 5 kWh/kg or less. One pass means that a raw material mixture is processed by the kneader once (from the input of the raw material mixture to the discharge thereof). When the mixing is insufficient, the raw material mixture may be again supplied from the supply opening, and further mixed.

A treatment temperature varies depending on the kinds of elements constituting a solid electrolyte to be obtained, a composition ratio, and the time of a reaction, and therefore may be suitably adjusted. In one embodiment of the present invention, a solid electrolyte precursor is heat-treated, and therefore does not need to be heated by a heating means (a heater or the like) provided in the kneader.

By performing a powder X-ray diffraction measurement of a treated product which has come out of the discharge opening of the kneader, it is possible to recognize whether the treated product is a raw material mixture, or a solid electrolyte precursor comprising glass or crystal which is a product resulting from the reaction of a compound or the like.

In one embodiment of the present invention, before the input of the compound or the simple substance to the kneader, the volume-based mean particle diameter of the compound or the simple substance is previously set preferably at 20 μm or less, more preferably at 15 μm or less, and particularly preferably at 12 μm or less.

The volume-based mean particle diameter (D₅₀) is measured by a laser diffraction particle size distribution measurement. The lower limit of the volume-based mean particle diameter is normally about 100 nm.

As a device used to grind the compound or the simple substance, it is possible to use a high-velocity rotation grinder, an impact type fine grinder, a container driving type mill, a medium stirring mill, or a jet mill. For example, the high-velocity rotation grinder includes a pin mill, the impact type fine grinder includes a pulverizer, the container driving type mill includes a ball mill, and the medium stirring mill includes a beads mill. Among others, the pin mill allows a short treatment time and is capable of a continuous grinding operation, and is therefore preferable. The treatment time by the pin mill is about several seconds, and extremely short.

Each of the compounds or the simple substances may be separately ground, or ground after mixed.

In the present invention, the raw material (raw material mixture or solid electrolyte precursor) is heat-treated in a flowing state. A device that can be used for the heat treatment includes a rotary furnace such as a rotary kiln.

In one embodiment of the present invention, the compound or the simple substance is preferably roughly mixed in advance before input to the kneader. A container rotation type mixer, a container fixed type mixer, a mortar, or the like can be used for the rough mixing. For example, a Nauta mixer which is a conical screw mixer, a Henschel mixer (FM mixer) which is a high-intensity stirrer/mixer, or the like can be used.

By heat-treating the raw material, it is possible to manufacture an argyrodite type solid electrolyte. A heat treatment temperature is preferably 350 to 500° C., further preferably 380 to 480° C., and particularly preferably 400 to 460° C.

Atmosphere of the heat treatment is not particularly limited, but is preferably atmosphere not under hydrogen sulfide airflow but under an inert gas such as nitrogen, argon, or the like.

Argyrodite type crystal structures include crystal structures disclosed in Patent Document 1 and the like. Composition formulas include, for example, Li₆PS₅X, Li₇₋ₓPS₆₋ₓXₓ (X=Cl, Br, I, x=0.0 to 1.8), and the like.

It is possible to ascertain by, for example, powder X-ray diffraction using Cu-Kα rays that a produced solid electrolyte has an argyrodite type crystal structure. An argyrodite type crystal structure has strong diffraction peaks at 2θ=25.2±1.0 deg and 29.7±1.0 deg. A diffraction peak of an argyrodite type crystal structure can also appear at, for example, 2θ=15.3±1.0 deg, 17.7±1.0 deg, 31.1±1.0 deg, 44.9±1.0 deg, or 47.7±1.0 deg. An argyrodite type solid electrolyte may also have these peaks.

In the present invention, as long as a solid electrolyte has an X-ray diffraction pattern of an argyrodite type crystal structure as described above, an amorphous component may be included in a part thereof. The amorphous component indicates a halo pattern in which the X-ray diffraction pattern does not substantially indicate peaks other than a peak derived from the raw material in the X-ray diffraction measurement. Moreover, a crystal structure other than the argyrodite type crystal structure, and raw materials may be included.

### EXAMPLES

The present invention is described below in more detail by Examples.

Evaluation methods are as follows.

(1) Volume-Based Mean Particle Diameter (D₅₀)

A measurement was performed with a laser diffraction/scattering type particle diameter distribution measurement device (manufactured by HORIBA, LA-950V2 model LA-950W2).

A mixture of dehydrated toluene (manufactured by Wako Pure Chemical Industries, Ltd., Special Grade) and tertiary butyl alcohol (manufactured by Wako Pure Chemical Industries, Ltd., Special Grade) at a weight ratio of 93.8:6.2 was used as a disperse medium. 50 mL of the disperse medium was poured into a flow cell of the device, and circulated. Thereafter, an object to be measured was added to the disperse medium, a resulting product was ultrasonically treated, and then particle diameter distribution was measured. The addition amount of the object to be measured was adjusted so that red light transmittance (R) corresponding to particle concentration was within 80 to 90% and blue light transmittance (B) was within 70 to 90% in a measurement screen defined by the device. Moreover, for operational conditions, 2.16 was used as a value of the refractive index of the object to be measured, and 1.49 was used as a value of the refractive index of the disperse medium. In the setting of a distribution form, the number of repetitions was fixed at 15, and the particle diameter was calculated.

(2) Ion Conductivity Measurement

The argyrodite type solid electrolyte manufactured in each Example was loaded into a tablet molding machine, and was formed into a mold by the application of a pressure of 22 MPa. Carbon was put as electrodes on both surfaces of the mold, and pressure was again applied to the mold by the tablet molding machine, whereby a mold for measurement (having a diameter of about 10 mm and a thickness of 0.1 to 0.2 cm) was produced. Regarding this mold, ion conductivity was measured by an alternating current impedance measurement. A numerical value at 25° C. was used as the value of conductivity.

(3) X-Ray Diffraction (XRD) Measurement

Powder of the argyrodite type solid electrolyte produced in each example was uniformly filled in a groove having a diameter of 20 mm and a depth of 0.2 mm by using glass to prepare a sample. This sample was measured with a Kapton Film for XRD such that the sample was not exposed to the air. A 2θ position of a diffraction peak was determined by Le Bail analysis using an XRD analytic program RIETAN-FP.

The measurement was conducted by use of a powder X-ray diffraction measurement device D2 PHASER of BRUKER corporation under the following conditions.

Tube voltage: 30 kV

Tube current: 10 mA

X-ray wavelength: Cu-Kα rays (1.5418 Å)

Optical system: concentration technique

Slit configuration: solar slit 4°, divergence slit 1 mm, Kβ filter (Ni plate) used

Detector: semiconductor detector

Measurement range: 2θ=10 to 60 deg

Step width, scan speed: 0.05 deg, 0.05 deg/sec

In the analysis of a peak position to ascertain the presence of a crystal structure by a measurement result, the XRD analytic program RIETAN-FP was used, a base line was corrected by 11th-degree Legendre orthogonal polynomials, and a peak position was found.

### Manufacture Example 1

### [Manufacture of Lithium Sulfide (Li₂S)]

Li₂S was manufactured and refined as below.

303.8 kg of toluene (manufactured by Sumitomo Corporation) which was dehydrated and had a moisture content of 100 ppm when measured by a Karl Fischer moisture meter was added as a nonaqueous medium to a 500 L stainless-steel reaction vessel under nitrogen airflow. Then 33.8 kg of anhydrous lithium hydroxide (manufactured by Honjo Chemical Corporation) was input, and kept at 95° C. while being stirred with a twin star stirring blade at 131 rpm.

The temperature was raised to 104° C. while hydrogen sulfide (manufactured by Sumitomo Seika Chemicals Co., Ltd.) was being blown into slurry at a supply velocity of 100 L/min. An azeotropic gas of water and toluene was continuously discharged from the reaction vessel. This azeotropic gas was condensed by an out-of-system condenser to achieve dehydration. In the meantime, the same amount of toluene as distilling toluene was continuously supplied, and a constant reaction liquid level was maintained.

The water content in condensate gradually decreased, and the distillation of water was no longer recognized in 24 hours after the introduction of hydrogen sulfide. During the reaction, solid matter was being dispersed and stirred in toluene, and no water was split from toluene.

Thereafter, hydrogen sulfide was changed to nitrogen which was circulated at 100 L/min for one hour.

An obtained solid content was filtered and dried, and Li₂S which was white powder was obtained. D₅₀ of Li₂S was 412 μm.

### Manufacture Example 2

Li₂S obtained in Manufacture Example 1 was ground under nitrogen atmosphere by a pin mill having a fixed quantity supplying machine (100UPZ manufactured by Hosokawa Micron Corporation). The input velocity was 80 g/min, and the rotation velocity of a disk was 18000 rpm.

Similarly, P₂S₅ (manufactured by Thermphos, D₅₀ was 125 μm), LiBr (manufactured by Honjo Chemical Corporation, D₅₀ was 38 μm), and LiCl (manufactured by Sigma-Aldrich Corporation, D₅₀ was 308 μm) were each ground by a pin mill. The input velocity of P₂S₅ was 140 g/min, and the rotation velocity of a disk was 18000 rpm. The input velocity of LiBr was 230 g/min, and the rotation velocity of the disk was 18000 rpm. The input velocity of LiCl was 250 g/min, and the rotation velocity of the disk was 18000 rpm. Thus, each ground raw material was obtained.

D₅₀ of Li₂S after ground was 7.7 μm, D₅₀ of P₂S₅ was 8.7 μm, D₅₀ of LiBr was 5.0 μm, and D₅₀ of LiCl was 10 μm.

### Example 1

Li₂S, P₂S₅, LiBr, and LiCl which were the ground raw materials obtained in Manufacture Example 2 were used as starting raw materials. In a globe box under nitrogen atmosphere, the starting raw materials prepared at a molar ratio of Li₂S:P₂S₅:LiBr:LiCl=47.5:12.5:15.0:25.0 so as to be 500 g in total were input to a high speed fluidizing mixer (SMP-1 manufactured by Kawata Mfg. Co., Ltd.), treated at a stirring velocity of 10 m/s for 30 minutes, and thus formed into a raw material mixture.

In the globe box under nitrogen atmosphere, 2.0 g of the raw material mixture was input to an inner case made of quartz. The inner case was connected to a rotary kiln (RK-0330 manufactured by Motoyama Corporation), and operated at a stirring (rotation) velocity of 3 rpm. The raw material mixture was raised to a temperature 460° C. from room temperature for 1.5 hours, and then treated for 2 hours. After the treatment, the mixture was naturally cooled to 100° C. or less, and a solid electrolyte was obtained. The yield of the solid electrolyte was 97.5%.

The ion conductivity (a) of the solid electrolyte was 6.7 mS/cm.

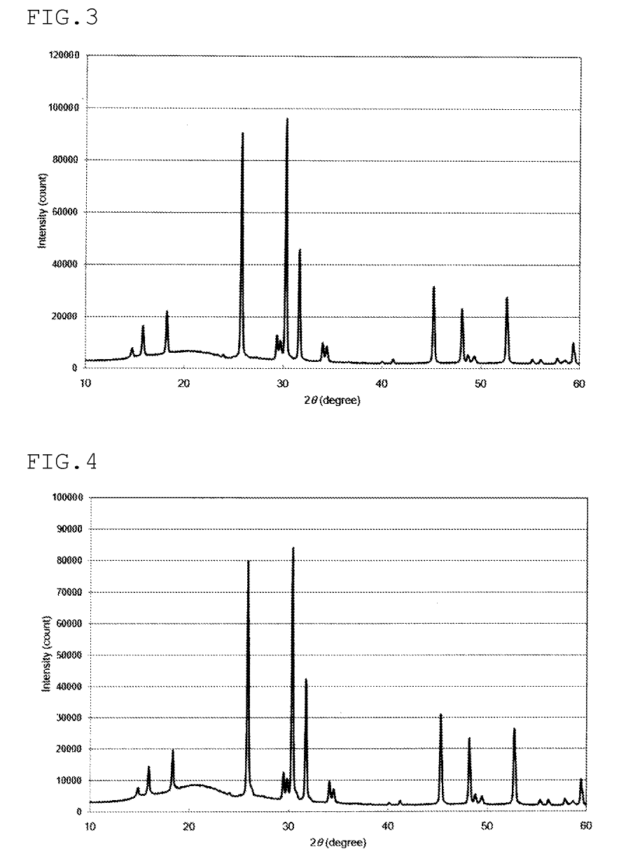

An XRD pattern of the solid electrolyte is shown in FIG. 3. Peaks derived from the argyrodite type crystal structure were observed at 2θ=15.8, 18.3, 25.8, 30.3, 31.7, 45.2, and 48.1 deg.

### Example 2

A solid electrolyte was obtained in a manner similar to Example 1 except that the rotation velocity of the rotary kiln was 10 rpm.

The ion conductivity (σ) of the solid electrolyte was 6.7 mS/cm. An XRD pattern of the solid electrolyte is shown in FIG. 4.

### Example 3

(A) Formation of Solid Electrolyte Precursor

In a globe box under nitrogen atmosphere, the same starting raw materials as those in Example 1 prepared at a molar ratio of Li₂S:P₂S₅:LiBr:LiCl=47.5:12.5:15.0:25.0 so as to be 400 g in total were input to a glass container, and roughly mixed by shaking the container.

400 g of the rough mixture was input to a biaxial kneader (manufactured by Kurimoto, Ltd., KRC-S1) at a velocity of 10 g/min, and the biaxial kneader was operated at a screw rotation number of 220 rpm. Integrated power in this instance was 0.10 kWh/kg.

40 g of an obtained raw material mixture was put in a sagger made of alumina, and heat-treated for 2 hours at 460° C. under nitrogen atmosphere. 30 g of an obtained heat-treated product was ground by a jet mill (NJ-50 manufactured by Aishin Nano Technologies Co. Ltd.) at an inlet pressure of 1.0 MPa, a grinding pressure of 0.8 MPa, and a treatment velocity of 120 g/h. Thus, 26 g of a solid electrolyte precursor was obtained.

(B) Heat Treatment Process

The solid electrolyte precursor obtained in (A) above was heat-treated by use of the rotary kiln under the same conditions as in Example 1, and a solid electrolyte was obtained. The yield of the solid electrolyte was 99.2%.

The ion conductivity (σ) of the solid electrolyte was 10.3 mS/cm.

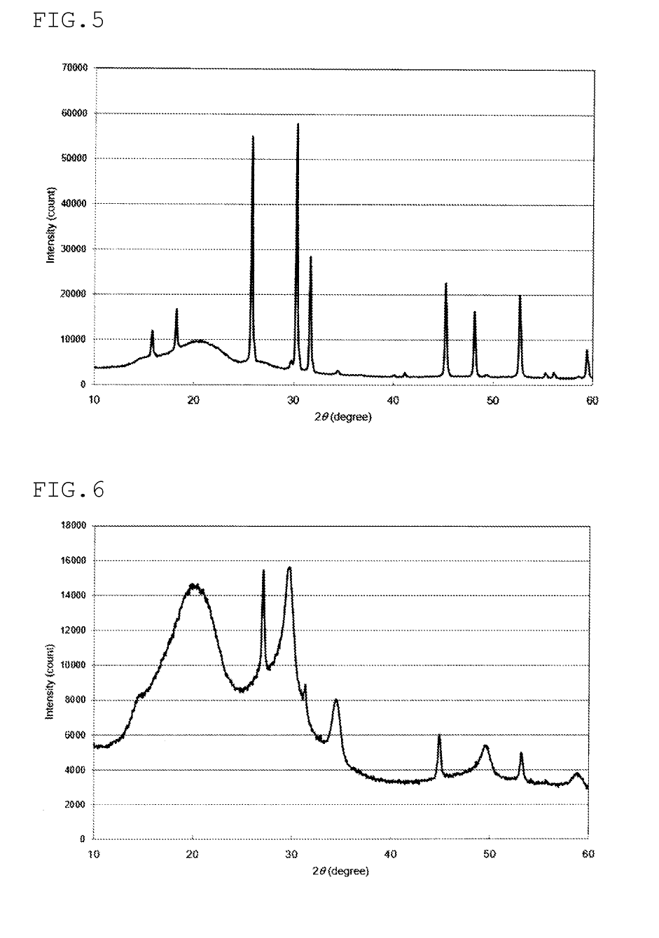

An XRD pattern of the solid electrolyte is shown in FIG. 5. Peaks derived from the argyrodite type crystal structure were observed at 2θ=15.8, 18.3, 25.8, 30.4, 31.7, 45.2, and 48.1 deg.

### Example 4

(A) Formation of Solid Electrolyte Precursor

Li₂S obtained in Manufacture Example 1, P₂S₅ (manufactured by Thermphos), LiBr (manufactured by Honjo Chemical Corporation), and LiCl (manufactured by Sigma-Aldrich Corporation) were used as starting raw materials. In a globe box under nitrogen atmosphere, the materials prepared at a molar ratio of Li₂S:P₂S₅:LiBr:LiCl=47.5:12.5:15.0:25.0 so as to be 250 g in total were input to a vibrating mill pot, treated for 120 hours under a condition at a frequency of 50 Hz by a vibrating mill (MB-3 manufactured by CHUO KAKOHKI CO., LTD.), and 210 g of a solid electrolyte precursor was obtained.

An XRD pattern of the solid electrolyte precursor is shown in FIG. 6. In the XRD pattern, a halo pattern derived from glass was observed.

(B) Heat Treatment Process

The solid electrolyte precursor was heat-treated by use of the rotary kiln under the same conditions as in Example 1 except that the heat treatment temperature was 400° C., and a solid electrolyte was obtained. The yield of the solid electrolyte was 99.7%.

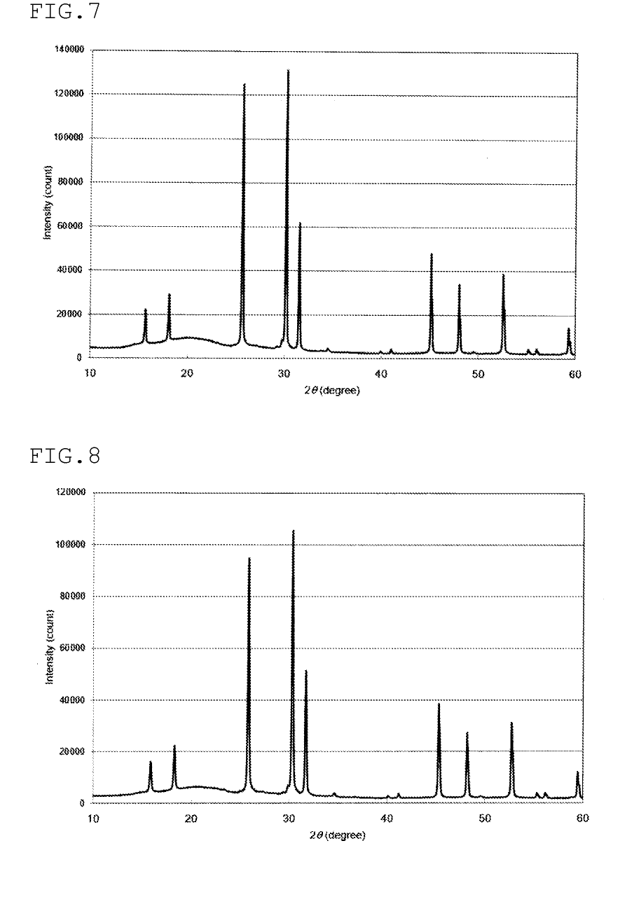

The ion conductivity (σ) of the solid electrolyte was 9.5 mS/cm. An XRD pattern of the solid electrolyte is shown in FIG. 7.

### Example 5

A solid electrolyte was obtained under the same conditions as in Example 4 except that the heat treatment temperature was 430° C. The yield of the solid electrolyte was 99.5%.

The ion conductivity (σ) of the solid electrolyte was 10.1 mS/cm.

An XRD pattern of the solid electrolyte is shown in FIG. 8. Peaks derived from the argyrodite type crystal structure were observed at 2θ=15.8, 18.3, 25.9, 30.3, 31.7, 45.3, and 48.2 deg.

Manufacturing conditions in Examples 1 to 5, whether or not there is adhesion to the inner case during the treatment, the yield of the solid electrolyte, D₅₀, and the ion conductivity are shown in Table 1.

TABLE 1

| | Rotation | Heat treatment | Adhesion | | Ion |
|---|---|---|---|---|---|
| | velocity | temperature | to | Yield | conductivity |
| Example | (rpm) | (° C.) | inner case | (%) | (mS/cm) |
| 1 | 3 | 460 | Yes | 97.5 | 6.7 |
| 2 | 10 | 460 | Yes | 99.5 | 6.7 |
| 3 | 3 | 460 | No | 99.2 | 10.3 |
| 4 | 3 | 400 | No | 99.7 | 9.5 |
| 5 | 3 | 430 | No | 99.5 | 10.1 |

From Examples 1 to 3, it is possible to ascertain that an argyrodite type solid electrolyte having high ion conductivity can be obtained in a short time by the manufacturing method according to the present invention. It can also be seen that in Examples 3 to 5, adhesion of the raw material to the device can be suppressed because the solid electrolyte precursor is heat-treated by the rotary kiln.

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention.

The documents described in the specification and the specification of Japanese application(s) on the basis of which the present application claims Paris convention priority are incorporated herein by reference in its entirety.

1. A method for producing a solid electrolyte, comprising heat-treating a raw material comprising lithium, sulfur, and phosphorus as constituent elements in a flowing state, thereby manufacturing a sulfide solid electrolyte comprising an argyrodite type crystal structure.

2. The manufacturing method according to claim 1, wherein the raw material further comprises halogen as a constituent element.

3. The manufacturing method according to claim 1, wherein the raw material is heat-treated by use of a rotary furnace.

4. The manufacturing method according to claim 1, wherein a solid electrolyte precursor is formed from two or more kinds of compounds or simple substances, and the solid electrolyte precursor is used as the raw material.

5. The manufacturing method according to claim 4, wherein the solid electrolyte precursor comprises glass, glass ceramics, or crystal.

6. The manufacturing method according to claim 4, wherein the solid electrolyte precursor is formed by applying mechanical stress to the two or more kinds of compounds or simple substances.

7. The manufacturing method according to claim 4, wherein mechanical stress is applied to the two or more kinds of compounds or simple substances by a vibrating mill or a multiaxial kneader.

8. The manufacturing method according to claim 4, wherein the two or more kinds of compounds or simple substances comprise lithium sulfide, phosphorus sulfide, and lithium halide.

9. The manufacturing method according to claim 8, wherein the lithium halide is lithium chloride or lithium bromide.

10. The manufacturing method according to claim 8, wherein the lithium halide is lithium chloride and lithium bromide.
